(19) United States
(12) Patent Application Publication
(10) Pub. No.: US 2006/0220919 A1
(43) Pub. Date: Oct. 5, 2006

(54) System for Monitoring and Tracking One or More Radioactive Sources

(76) Inventor: Robert W. Pitts JR., Houston, TX (US)

Correspondence Address: TIM COOK, P.O. BOX 10107, LIBERTY, TX, 77575, US

(21) Appl. No.: 10/907,473

(22) Filed: Apr. 1, 2005

(51) Int. Cl. G08B 23/00

(52) U.S. Cl. 340/963

(57) ABSTRACT

A system for tracking and monitoring one or more radioactive sources as the sources are transported or stored. The system continuously and automatically monitors each source for a security breach, which includes tampering, moving, exchange or removal of a source by unauthorized personnel. Any security breach is immediately reported to a remote monitoring station, wherein the report contains pertinent information relating to the breach. Status reports of the one or more monitored and tracked sources are automatically transmitted to the remote monitoring station at predetermined time intervals. In addition, a status report of one or more sources can be obtained by means of a query from the remote monitoring station.

### FIELD OF THE INVENTION

This invention relates generally to the field of tracking and monitoring of radioactive sources. More particularly, the system is directed toward tracking and monitoring one or more radioactive sources as they are transported or stored, and the detection, at a remote monitoring station, of any unauthorized tampering, exchange, or removal of one or more sources.

### BACKGROUND OF THE INVENTION

Monitoring, tracking, and inventorying of radioactive sources have been required by various corporate, government, and international regulatory agencies for many years. These have traditionally been manual tasks requiring much time, energy and cost. In recent years, monitoring and tracking of sources have become even more critical. As an example, the International Atomic Energy Authority (IAEA) requires that certain types and strengths of radioactive sources, defined as “sources of concern”, be tracked continuously as they are physically transported or stored. Sources of concern are defined by type and strength. As an example, the IAEA defines any Americium berillium-241 (²⁴¹AmBe) of source strength greater than 16.7 Curies (Ci) as a source of concern.

Sources of concern are used in many commercial operations that require transportation of the sources to remote geographic locations, and subsequent storage of the sources when the operations are completed. As an example, ²⁴¹AmBe sources exceeding the 16.7 Ci level are used in a wide variety of geophysical well logging systems, which require the sources to be transported typically by truck to remote oil and gas well sites. As another example, isotopic gamma ray sources of concern such as ⁶⁰Co and ¹³⁷Cs are used in a wide variety of pipeline inspection and geophysical well logging systems, which again require these sources to be transported to remote locations. It is highly desirable, if not actually required in certain situations, for all types and strengths of radioactive sources to be monitored continuously, during storage and transportation, for security breaches such as unauthorized tampering, exchange, or removal. If detected, the security breach should be immediately reported to the appropriate authorities.

Thus, there remains a need for a system for identifying, tracking, monitoring, and inventorying radioactive sources to reduce the burden and cost of current manual systems. The present invention is directed to filling this need in the art.

### SUMMARY OF THE INVENTION

This invention provides such a system for identifying, monitoring, and tracking radioactive sources, and in particular neutron and gamma ray sources. A plurality of sources at diverse geographic locations can be tracked from a remote, central monitoring station.

The system comprises a source monitor unit that can be disposed near, attached to, or integrated within a source container which comprises shielding material in which a radioactive source is removably disposed. The source monitor unit is controlled by a preprogrammed internal processor, thereby continuously and automatically transmitting information regarding the source to the remote monitoring location. The source monitor unit can also be queried or “polled”, and even overridden, from the remote monitoring station. The source monitor unit can be manually activated or deactivated by authorized personnel using a manual input such as a key pad, magnetic card reader, and the like. Any manual intervention is detected at the remote monitoring station to confirm that the intervention is authorized and is not an attempt to breach the security of the source.

The source monitor unit is in two-way communication with the remote monitoring station via a communication link. This communication link can comprise a cell phone, two-way radio, satellite, and the like, or land telephone lines if the source is not being transported.

A variety of information is transmitted by the source monitor unit. Radiation intensity, preferably in the form of count or count rate data, is automatically and continuously transmitted to the remote monitoring station along with an identifier such as a source serial number. In addition, time of day, type of radiation source, radiation intensity, and geographic location of the source is automatically transmitted to the remote monitoring station at predetermined time intervals. All of the above information is transmitted immediately if the source security is breached, wherein source security breach includes tampering with the source or the source container, and exchanging or removing the source by unauthorized personnel. The information is also transmitted upon query or “polling” by the remote monitoring station. Various information can also be entered into the source monitor unit manually via the manual input as the source, container, and monitor unit pass through check points and the like.

These and other features and innovations of the present invention will be readily apparent to those of skill in the art from a review of the following detailed description along with the accompanying drawings.

### BRIEF DESCRIPTION OF THE DRAWINGS

So that the manner in which the above recited features, advantages, and objects of the present invention are obtained and can be understood in detail, more particular description of the invention, briefly summarized above, may be had by reference to the embodiments thereof which are illustrated in the appended drawings.

FIG. 1 is a functional diagram of key elements of the source monitor unit contained within a unit housing;

FIG. 2 illustrates an embodiment of the invention wherein the source monitor unit is fabricated as an integral part of a source container;

FIG. 3 illustrates a plurality of source monitor units linked to a single remote monitoring station;

FIG. 4 is a flow chart of for processing detector response data from the source monitor unit; and

FIG. 5 illustrates conceptually a source and source container being transported by a vehicle, with an attached source monitor unit in continuous communication with a remote monitoring station.

### DETAILED DESCRIPTION OF PREFERRED EMBODIMENTS

The Monitor Unit

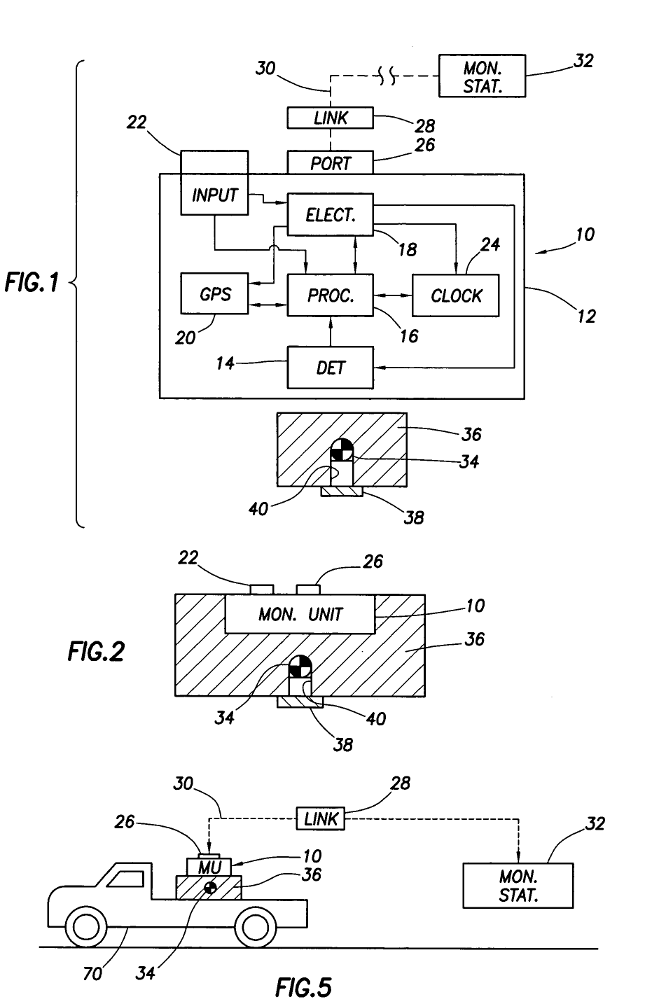

FIG. 1 is a functional diagram of key elements of the source monitor unit 10 contained within a unit housing 12. Detector 14 is responsive to radiation emitted by a source 34 within the source container 36. The source 34 is inserted through a conduit 40 and secured with a cover 38. The radiation emitted from the source container 36 can comprise neutron radiation, gamma radiation, or both neutron and gamma radiation. The detector can comprise a neutron detector, a gamma ray detector, or a detector responsive to both neutron and gamma radiation. Alternately, the detector 14 can comprise a plurality of detectors responsive to one or more types of radiation in one or more radiation energy ranges. As examples, the detector 14 can comprise a scintillation crystal, a solid state radiation detector, a gas type radiation detector, and the like.

Still referring to FIG. 1, all detected radiation is not necessarily emitted directly from the source 34. The detector 14 is also responsive to radiation induced in surrounding materials (not shown) by the source 34. As an example, if the source 34 emits neutrons, a portion of the neutron flux can be elastically or inelastically scattered by material in the vicinity of the source container and source monitor unit 10 thereby producing secondary neutron and neutron induced scatter gamma radiation. As another example, a neutron emitting source can produce thermal neutron capture gamma radiation and neutron activation radiation in surrounding materials, again generating a secondary gamma radiation flux. Changes in the secondary neutron and gamma radiation fluxes measured by the detector 14 can be used to indicate that the source container 36 has been altered, or that the source container 36 has been physically moved with respect to the source monitor unit 10. Both observations may indicate a source security breach.

Again referring to FIG. 1, the detector 14 is operationally connected to a processor 16 which contains memory for storing measured detector count data, operating software, and the like. The processor 16 is also operationally connected to a clock 24, and to an electronics package 18. The electronics package 18 provides power for the processor 16, the clock 24, and the detector 14. The electronics package 18 also comprises a transceiver, discussed below.

It is desirable to know the physical position of the source monitor unit 10 at all times. This is accomplished using a global positioning system (GPS) 20 that is operationally connected to the processor 16 and powered by the electronics package 18. Many transport vehicles are also GPS equipped. It should be understood that the integrated GPS element 20 can optionally be eliminated in this case, and position information can be input to the source monitor unit 10 by the vehicle's GPS (not shown). Alternatively, the GPS unit of the source monitor unit 10 may be associated with the GPS unit of the vehicle, and a substantial change in the relative positions of the associated GPS unit may indicate a breach during transport of the source.

Again referring to FIG. 1, the source monitor unit 10 is in two-way communication, via the transceiver in the electronics package through a link 28, with a remote monitoring system 32 as illustrated conceptually by the broken line 30. The link 28 can be a cell phone, a two-way radio system, a satellite communication system and the like. If the source monitor unit is stationary, the link can comprise telephone land lines. Data are input and output from the processor 16 using the previously mentioned transceiver within the electronics package 18 through an input/output (I/O) port 26. The transceiver within the electronics package 18 is, of course, compatible with the type of communication link 28 employed. Transmitted data are also formatted to be compatible with the type of communication link.

The source monitor unit 10 shown in FIG. 1 is controlled by the preprogrammed internal processor 16, but can also be queried or polled from the remote monitoring station 32 via the two-way communication link 28. Programming changes can also be downloaded from the remote monitoring station 32 to the source monitor unit 10 via the two-way communication link 28.

The source monitor unit 10 can be manually activated or deactivated by authorized personnel using a manual input 22 such as a key pad, magnetic card reader, and the like. Any manual intervention is detected at the remote monitoring station 32 to confirm that the manual intervention is authorized and is not an attempt to breach the security of the source 34.

### Data Processing

The following describes one method for processing response data measured by the detector 14 of the source monitor unit 10 shown in FIG. 1, although other methods may be employed within the scope and spirit of the invention. Processing occurs within the processor 16, under the control of appropriate software residing within the processor. Other effective methods can be used to process detector response data and thereby detect a source security breach. In the context of this disclosure, a source security breach by unauthorized personnel includes the acts of tampering with the source or the source container, moving or removing the source container, exchanging radioactive sources disposed within the source container, and removing the radioactive source from the source container.

Counts Cᵢ from the detector 14 are summed within the processor 16 over time intervals tᵢ, where values of tᵢ are preferably contiguous to minimize statistical error in measurements. It is also preferred that all time intervals tᵢ are equal. Values of Cᵢ, where (i=1, . . . n) are measured and an average count C_{A} is computed from the equation

$${C}_{A} = {\sum }_{i = 1}^{n} {C}_{i} / n \qquad ( 1 )$$

The absolute difference /Cᵢ−C_{A}/ between the current Cᵢ and the updated C_{A} is compared with a predetermined statistical variation limit ε. If

(2)/Cᵢ−C_{A}/<ε

then the source integrity has not been tampered with, changed, or removed, and there is no security breach. The integer i is then incremented within the processor 16, the incremented value of i is compared to a report integer K for reasons to be subsequently disclosed, and a new value Cᵢ is measured with i incremented. The average C_{A} is updated in the processor 16, and the comparison shown in equation (2) is again made to check for any security breach during the incremented time interval.

If the comparison expressed mathematically in equation (2) fails, a security breach is indicated. The processor 16 initiates a report to be transmitted to the remote monitoring station 32 via the link 28. The report first and foremost is a notification of a source security breach, with the source being identified preferably by serial number. The report also preferably includes the time of day that the breach occurred as indicated by the clock 24, the geographical location of the breach as indicated by the GPS 20, the type of measured radiation, and the last measured count valued Cᵢ that can be used to indicate that the security breach comprises tampering with or moving the source container 36, an exchange of source 34, or complete removal of the source from the container 36.

Assuming that no security breaches are indicated by the comparison of equation (2), a source status report is optionally transmitted from the source monitor unit 10 to the remote monitoring station 32 when i reaches a predetermined report integer K, which is preferably preprogrammed in the processor software. Assume for purposes of discussion that tᵢ is programmed in the processor 16 to be 5 minutes and K is preprogrammed to be 12, then a source status report will be automatically and continuously transmitted to the remote monitoring station every hour. It should be understood that other time intervals tᵢ and other report integers K can be selected to vary the intervals between automatic source status reports.

As a second example, tᵢ is programmed in the processor 16 to be 1 second and K is preprogrammed to be 60, then a source status report will be automatically and continuously transmitted to the remote monitoring station every minute. In addition, every value Cᵢ can be transmitted automatically and continuously to the remote monitoring station. Furthermore, K can be set to unity thereby transmitting a source status report with every value Cᵢ.

As mentioned previously, other methodologies can be used to detect a source security breach using process response data generated the detector 14 of the source monitor 12. As an example, count rate from the detector 14 can be computed either continuously or over predetermined time intervals tᵢ. If the count rate deviates significantly from a running average of count rate, or alternately from a predetermined “calibration” count rate, a source security breach is indicated.

In summary, response data from the detector 14 are processed within processor 16 of the source monitor unit 10 to identify a breach in source security, and information regarding the breach is automatically transmitted to the remote monitoring station 32.

### Other Embodiments

FIG. 2 illustrates an embodiment of the invention wherein the source monitor unit 10 is fabricated as an integral part of a source container 36. As in the embodiment shown in FIG. 1, the I/O port 26, the manual input 22, the source conduit 40, and source cover 38 are easily accessible.

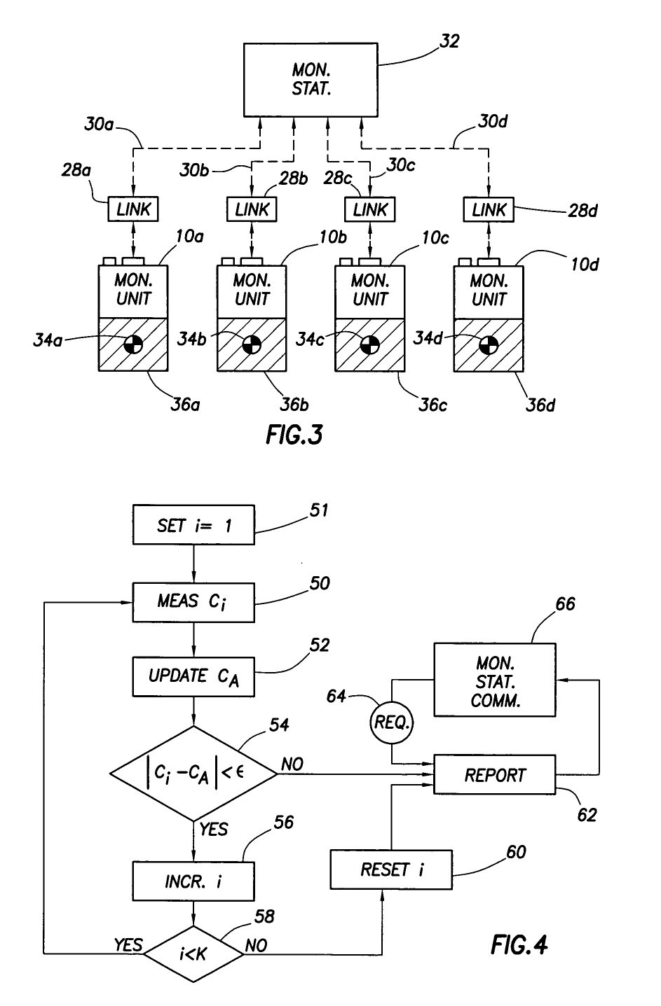

FIG. 3 illustrates a plurality of source monitor units linked to a single remote monitoring station 32. For purposes of illustration, four sources 35a, 35b, 35c and 35d are disposed in source containers 36a, 36b, 36c, and 36d which are attached to source monitor units 10a, 10b, 10c and 10d, respectively. The source container and monitor units can be at widely diverse geographic locations. Some can be stationary and some can be mobile. The only requirement for monitoring is that communication links 28a, 28b, 28c, and 28d be able to establish two-way communication with the remote monitoring system 32 as illustrated conceptually by the broken lines 30a, 30b, 30c, and 30d, respectively. If one or more sources and accompanying monitor units are disposed where communication can not be established (such as the hold of a ship), those units are disabled by authorized personnel preferably by inserting an authorization code the unit's manual input 22. The unit can subsequently be reactivated by means of the manual input if, as an example, a unit in the hold of a ship can be attached to a suitable external antenna thereby linking again to the remote monitoring station 32.

From the conceptual illustration of FIG. 3, it is apparent that numerous, widely dispersed sources of radiation can be effectively and continuously monitored for security breaches at a single remote monitoring station by a single individual.

FIG. 4 is a flow chart of data processing methodology discussed previously in conjunction with FIG. 1. Typically, FIG. 4 represents a flow chart of response data processing software that resides within the processor 16. The time interval identifying integer i is initially set to 1 at step 51. Detector counts Cᵢ are summed over the corresponding time interval tᵢ at step 50. This measurement is used to update the count average C_{A} at step 52. The absolute difference between the current Cᵢ and the updated C_{A} is compared with a predetermined statistical variation limit ε at step 54. If the comparison is satisfied (i.e. less than ε), i is incremented at step 56 and compared with the report integer K at step 58. If i=K, the process is repeated starting at step 50. If the comparison at step 54 is not satisfied or if i=K at step 58, a status report is generated for the monitored source at step 62, and transmitted to the remote monitoring station 32. Each measured value of Cᵢ can be transmitted to the remote monitoring station in addition to the status reports. Details of the status report, and the use of the report to determine the type of security breach (if any), have been discussed previously. A request 64 for a status report can be initiated by an operator of the remote monitoring station 32 at any time. Stated another way, the operator has the prerogative to poll the status of any or all sources being monitored at any time, due to circumstances that might be encountered. In addition, periodic polls can be initiated at the remote monitoring station 32 at any time to insure that the two-way communication link 28 is operating properly and has not been disabled or destroyed clandestinely.

FIG. 5 illustrates conceptually a source 34 disposed in a source container 36 being transported by a vehicle 70. The source monitor unit 10, which is attached to the source container 36, is in continuous two-way communication with the remote monitoring station 32 through the I/O port 26 and connecting link 28, as indicated by the broken lines 30. As discussed at length above, any tampering, exchange or removal of the source will be automatically transmitted to the remote monitoring station 32, the status of the source can be polled at any time from the remote monitoring station, and the proper operation of the link 28 can be determined at any time via instruction from the remote monitoring station. Furthermore, continuous count data can be transmitted.

While the foregoing disclosure is directed toward the preferred embodiments of the invention, the scope of the invention is defined by the claims, which follow.

1. A system for monitoring a radioactive source, the system comprising:
(a) a source monitor unit disposed in the vicinity of said radioactive source, wherein said source monitor comprises a detector yielding response data indicative of said radioactive source and further comprising a manual input device for manually activating and deactivating the source monitor, unit by authorized personnel; and
(b) a remote monitoring station operationally connected to said source monitor unit via a communication link, wherein
(i) said response data are transmitted to said remote monitoring station,
(ii) said response data are processed within said source monitor unit to identify a breach in security of said source; and
(iii) information regarding said security breach is transmitted to said remote monitoring station.

2. The system of claim 1, wherein response data are automatically and continuously transmitted to said remote monitoring station from the source monitor unit and wherein said response data are continuously processed within said source monitor unit.

3. The system of claim 1 wherein said detector is responsive to radiation selected from the group consisting of neutron radiation and gamma radiation.

4. The system of claim 1 wherein said communication link comprises a cell phone.

5. The system of claim 1 wherein information regarding said security breach comprises at least one of:
(a) a source identification number;
(b) time of said security breach;
(c) said response data at said time of said security breach; and
(d) geographic location of said source at said time of said security breach.

6. The system of claim 1 wherein said source monitor unit generates a source status report comprising at least one of:
(a) a source identification number;
(b) time of day;
(c) said response data at said time of day; and
(d) geographic location of said source.

7. The system of claim 6 wherein said source status report is transmitted automatically to said remote monitoring station at a predetermined time interval.

8. The system of claim 6 wherein said report is transmitted to said remote monitoring station upon receipt of a query by said source monitor unit from said remote monitoring station.

9. A system for monitoring a plurality of radioactive sources, the system comprising:
(a) a plurality of source monitor units; wherein
(i) an associated source monitor unit is disposed in the vicinity of a corresponding radioactive source, and
(ii) each said source monitor unit comprises a detector yielding response data indicative of said corresponding radioactive source and further comprises a manual input device for manually activating and deactivating the source monitor unit by authorized personnel; and
(b) a remote monitoring station operationally connected to each said source monitor unit via a corresponding communication link, wherein
(i) said response data from each said radioactive source are continuously and automatically transmitted to said remote monitoring station,
(ii) each said source monitor unit processes said response data from said corresponding radioactive source to generate a source status report,
(iii) said source status report is automatically transmitted to said remote monitor station at predetermined time intervals,
(iv) each said source monitor unit continuously processes response data from said corresponding radioactive source to identify a breach in security of said corresponding source, and
(v) information regarding said security breach is automatically transmitted to said remote monitoring station.

10. The system of claim 9 wherein said detector is responsive to neutron radiation.

11. The system of claim 9 wherein said detector is responsive to gamma radiation.

12. The system of claim 9 wherein said communication link comprises a cell phone.

13. The system of claim 9 wherein said information regarding said security breach comprises:
(a) an identification number of said source whose security is breached;
(b) time of said security breach;
(c) response data at said time of said security breach; and
(d) geographic location of said source whose security is breached at said time of said security breach.

14. The system of claim 9 wherein said source status report for each said plurality of radioactive sources comprising:
(a) a source identification number;
(b) time of day;
(c) response data at said time of day; and
(d) geographic location of said source.

15. The system of claim 9 wherein said source status report is transmitted to said remote monitoring station upon receipt of a query by said corresponding source monitor unit from said remote monitoring station.

16. A method for monitoring a radioactive source, the method comprising:
(a) disposing a source monitor unit in the vicinity of said radioactive source, wherein said source monitor comprises a detector yielding response data indicative of said radioactive source;
(b) operationally connecting a remote monitoring station to said source monitor unit via a communication link;
(c) continuously and automatically transmitting said response data to said remote monitoring station;
(d) continuously processing within said source monitor unit said response data to identify a breach in security of said source;
(c) automatically transmitting information regarding said security breach to said remote monitoring station; and
(f) manually activating and deactivating the source monitor unit by authorized personnel using a manual input device.

17. Method of claim 16 wherein said breach in security is identified by comparing said response data with an average of said response data over a predetermined period of time.

18. The method of claim 16 wherein:
(a) information regarding said security breach comprises
(i) a source identification number,
(ii) time of said security breach,
(iii) said response data at said time of said security breach, and
(iv) geographic location of said source at said time of said security breach; and
(b) said information is automatically transmitted to said remote monitoring station at said time of said security breach.

19. The method of claim 16 comprising the additional steps of:
(a) generating, within said source monitor unit, a source status report comprising
(i) a source identification number,
(ii) time of day,
(iii) said response data at said time of day, and
(iv) geographic location of said source; and
(b) transmitting said source status report to said remote monitoring station at predetermined time intervals.

20. The method of claim 19 comprising the additional step of transmitting said source status report to said remote monitoring station upon receipt of a query by said source monitor unit from said remote monitoring station.
